(19) United States
(12) Patent Application Publication
(10) Pub. No.: US 2020/0067106 A1
(43) Pub. Date: Feb. 27, 2020

(54) DRIVING HETEROGENEOUS CATALYSIS VIA ELECTROCHEMICAL PROTON PUMPING IN PROTON-ELECTRON CONDUCTING FILMS

(71) Applicant: Massachusetts Institute of Technology, Cambridge, MA (US)

(72) Inventors: Yogesh Surendranath, Cambridge, MA (US); Bing Yan, Cambridge, MA (US); Marcel Schreier, Cambridge, MA (US)

(21) Appl. No.: 16/537,209

(22) Filed: Aug. 9, 2019

Related U.S. Application Data
(60) Provisional application No. 62/717,381, filed on Aug. 10, 2018.

(51) Int. Cl. H01M 8/0241; C25B 1/10; B01J 23/42; B01J 23/46; H01M 8/1004

(52) U.S. Cl. CPC H01M 8/0241; C25B 1/10; H01M 8/1004; B01J 23/468; B01J 23/42

(57) ABSTRACT

Disclosed are devices capable of heterogeneous electrochemical catalysis. Also disclosed are methods of using the devices in various electrochemical reactions.

### RELATED APPLICATIONS

This application claims the benefit of priority to U.S. provisional patent application No. 62/717,381, filed Aug. 10, 2018.

### GOVERNMENT SUPPORT

This invention was made with Government support under Grant No. CHE-1454060 awarded by the National Science Foundation. The Government has certain rights in the invention.

### BACKGROUND

Many industrially important commodity conversions involve the transfer of hydrogen atoms. For example, hydrogen oxidation, methanol oxidation and formic acid oxidation, all of which are anode reactions for fuel cells; alkane dehydrogenation, generating alkenes that are precursors for higher order industrial products; and carbon dioxide and carbon monoxide reduction to useful chemicals. However, many of these conversions require harsh conditions, for example, strong acids and bases, fragile catalysts, high temperatures, and pressures (e.g., the Haber-Bosch process). Thus, there exists a need for robust catalysts that can catalyze these vital chemical conversions under mild conditions.

### SUMMARY

The present disclosure provides devices capable of catalyzing a range of industrially important chemical transformations.

In one aspect, the device comprises a porous support substrate, and a film in contact with the porous support substrate, wherein the film comprises:

a first oxide layer; and

an ionic conductor layer; wherein
the oxide is selected from the group consisting of WO₃, WO₂, MoO₃, MoO₂, TiO₂, TiO, ZnO, ZrO₂, ZrO, CeO₂, CeO, TiCeO₂, YCeO₂, carbon, V₂O₅, MoS₂, WS₂, NiOOH, MnO₂, SnO₂, Fe₂O₃, and CrOₓ, wherein x is a number from 0.1 to 3; and
the ionic conductor is selected from the group consisting of an electrolyte, a polymer membrane, and an inorganic compound.

In another aspect, the device comprises a porous support substrate, and a film in contact with the porous support substrate, wherein the film comprises:

a first catalyst layer;

a first oxide layer; and

an ionic conductor layer; wherein
the catalyst is selected from the group consisting of a metal, a metal nitride, a metal oxide, a metal sulfide, a metal carbide, Pt, Pd, Ru, Re, Co, Cu, Rh, CoMo, NiMo, NiW sulfide, Ni, Fe, and Au;
the oxide is selected from the group consisting of WO₃, WO₂, MoO₃, MoO₂, TiO₂, TiO, ZnO, ZrO₂, ZrO, CeO₂, CeO, TiCeO₂, YCeO₂, carbon, V₂O₅, MoS₂, WS₂, NiOOH, MnO₂, SnO₂, Fe₂O₃, and CrOₓ, wherein x is a number from 0.1 to 3; and
the ionic conductor is selected from the group consisting of an electrolyte, a polymer membrane, and an inorganic compound.

In yet another aspect, the device comprises a porous support substrate, and a film in contact with the porous support substrate, wherein the film comprises:

a first catalyst layer;

a first oxide layer;

an ionic conductor layer;

a second oxide layer; and

a second catalyst layer; wherein
each catalyst is independently selected from the group consisting of a metal, a metal nitride, a metal oxide, a metal sulfide, a metal carbide, Pt, Pd, Ru, Re, Co, Cu, Rh, Pt sulfide, Pd sulfide, Rh sulfide, CoMo sulfide, NiMo sulfide, NiW sulfide, Ni, Fe, and Au;
the oxide is selected from the group consisting of WO₃, WO₂, MoO₃, MoO₂, TiO₂, TiO, ZnO, ZrO₂, ZrO, CeO₂, CeO, TiCeO₂, YCeO₂, carbon, V₂O₅, MoS₂, WS₂, NiOOH, MnO₂, SnO₂, Fe₂O₃, and CrOₓ, wherein x is a number from 0.1 to 3; and
the ionic conductor is selected from the group consisting of an electrolyte, a polymer membrane, and an inorganic compound.

In certain aspects, the present disclosure provides methods of using the aforementioned devices to perform chemical transformations.

### BRIEF DESCRIPTION OF THE DRAWINGS

FIG. 1A depicts a cross-section SEM image of a magnetron sputter deposited Pt/WO₃ film, supported on a porous polycarbonate membrane.

FIG. 1B depicts a top-down SEM image of a Pt/WO₃ film.

FIG. 1C depicts a transmission electron microscopy (TEM) image of Pt particles supported on WO₃, both of which were magnetron sputter deposited on a Cu/lacey carbon TEM grid. The white circles were drawn to guide the eyes to the Pt particles.

FIG. 1D depicts X-ray photoelectron spectroscopy (XPS) of the W 4f region on the surface (black), and after one cycle of Ar⁺ sputter (red) for the Pt/WO₃ surface.

FIG. 1E depicts the XPS of Pt 4f region on the Pt/WO₃ film surface.

FIG. 1F depicts an exemplary schematic of the WO₃ and Pt fabrication process, and the assembly into a working electrode.

FIG. 1G depicts X-ray photoelectron spectroscopy (XPS) of the W 4f region for the Pt/WO₃ surface.

FIG. 1H depicts an transmission electron microscopy (TEM) image of Pt particles supported on WO₃, both of which were magnetron sputter deposited on a Cu/lacey carbon TEM grid. The white circles were drawn to guide the eyes to the Pt particles.

FIG. 2A depicts cyclic voltammetry plots for the Pt/WO₃ working electrode with N₂ (red) and H₂ (black) being supplied.

FIG. 2B depicts the steady-state H₂ oxidation current density versus potential for Ar-saturated (black squares), O₂-saturated (grey squares) and CO-saturated (triangles) electrolyte.

FIG. 2C depicts cyclic voltammetry plots for the Pt/WO₃ working electrode with N₂ (red) and H₂ (black) being supplied.

FIG. 2D depicts the steady-state H₂ oxidation current density versus potential for Ar-saturated (squares), O₂-saturated (squares) and CO-saturated (triangles) electrolyte.

FIG. 3 depicts the H₂ oxidation current density at 0.50 V polarization when 10 mM Cu²⁺ was added to the electrolyte.

FIG. 4 depicts the adsorption of hydrogen onto an exemplary catalyst surface (i.e., palladium).

FIG. 5A depicts the partial reduction of WO₃.

FIG. 5B depict the mobility of electrons in WO₃.

FIG. 5C depicts the mobility of protons in WO₃.

FIG. 6 depicts a schematic of an exemplary device of the disclosure.

FIG. 7A depicts the correlation between HOR current and the thickness of the catalyst (e.g., platinum).

FIG. 7B depicts the correlation between HOR current and the thickness of the catalyst (e.g., platinum).

FIG. 8A depicts the correlation between HOR current and the thickness of the metal oxide (e.g., WO₃).

FIG. 8B depicts the correlation between HOR current and the thickness of the metal oxide (e.g., WO₃).

FIG. 9 depicts the correlation between HOR current and acidity.

FIG. 10 depicts the pathway of H₂ to proton conversion of an exemplary catalyst/oxide pairing (e.g., platinum and WO₃).

FIG. 11 depicts the selectivity of exemplary devices of the disclosure.

### DETAILED DESCRIPTION

Transition metal oxides, including but not limited to tungsten oxide, molybdenum oxide and titanium oxide, exhibit mixed electron and ion conductivity at room temperature. Importantly, when in contact with an electrolyte, these materials allow for the electrically driven intercalation and deintercalation of cations, protons in particular, from or into the electrolyte. This property allows for the electrochemical control of the proton concentration within the material. Simultaneously, proton-electron pairs (i.e., hydrogen atoms) can flow between the metal oxide and a contacting catalyst, such as platinum or palladium. These two noble metals have, for example, been widely adopted as heterogeneous catalysts for a great number of important reactions such as oxygen reduction, hydrogen oxidation, methanol oxidation, carbon dioxide and carbon monoxide hydrogenation, alkane dehydrogenation, hydrogenation reactions, to name but a few. By exploiting the spillover of hydrogen between the metal oxide to the catalyst, the electrochemical control of heterogeneous catalytic processes becomes possible.

This process is illustrated, for example, by the simple oxidation of hydrogen using a Pt/WO₃ interface. Therein, H₂ dissociatively adsorbs on platinum as hydrogen atoms at the transition metal oxide/platinum/gas interface. Subsequently, hydrogen migrates across the Pt/WO₃ interface to WO₃. Intercalation of hydrogen into the oxide material reduces tungsten(VI) to tungsten(V), converting the semi-conducting tungsten trioxide to metallic conducting tungsten bronze. Under applied anodic potentials and in contact with an electrolyte, electrons are driven through the external circuit while protons migrate into the electrolyte. As an overall result, hydrogen gas is oxidized to protons. Similarly, the reverse process is possible, wherein protons are electrochemically transported from the solution into WO₃, followed by the spillover onto Pt and evolution of hydrogen at the WO₃/Pt catalyst interface.

The herein described technology reduces the commonly used electrochemical interface from a 3-phase boundary comprising electrolyte, substrate-phase and conducting phase to a 2-phase boundary comprising a mixed electron-proton conductor in contact with the substrate phase, thereby leading to substantially improved mass transport in electrochemically driven processes near room temperature. Importantly, the substrate-phase at the metal oxide/metal interface can either be a gas or a liquid phase. Furthermore, this technology allows for full control of the proton-electron migration direction and rate and proton-electron concentration in the intercalation material. Thus, allowing for active control of dehydrogenation and hydrogenation reactions taking place on the solid-substrate interface.

Furthermore, the devices described herein can be employed as a selective catalytic interface. WO₃ is inert towards the electrochemical O₂ reduction. Thus, the Pt/WO₃ composite can be polarized in presence of dissolved O₂ in the electrolyte, while not leading to oxygen reduction current. The sole catalytic process taking place under these circumstances happens at the substrate-solid interface, thus making the device a selective anode catalyst for membrane-free fuel cells.

Herein the technology is exemplified using WO₃ as an example ion intercalation material. However, the same description applies to all other suitable intercalating mixed ion-electron conductors that are described herein.

### Hydrogen Spillover From a Metal to WO₃

Substrate molecules, such as those described herein (e.g., hydrogen, alkanes, alkenes and oxygenates, etc.) dissociatively adsorb on metals to form H atoms. When the metal is in contact with WO₃, hydrogen atoms migrate across the metal-WO₃ interface to intercalate into WO₃. The resulting H-intercalated HₓWO₃ is called tungsten bronze. Unlike WO₃ which is in light yellow color and is a wide band-gap semi-conductor, HₓWO₃ is a metallic conductor due to the partial reduction of W(VI) to W(V). The intervalence charge transfer between W(VI) and W(V) gives rise to the dark blue color of tungsten bronze. Here we utilize the hydrogen spillover phenomenon to activate the substrate molecules as hydrogen atoms are intercalated in WO₃. The overall effect results in the dehydrogenation of the substrate.

### Charge Separation and H-to-Proton Conversion

Once partially reduced to tungsten bronze, the material becomes a metallic conductor with high electron mobility. The intercalated H atoms undergo charge separation during which electrons are inserted into the d-band of tungsten while protons bind to coordinate oxygen atoms. The protons can move between neighboring oxygen atoms with a moderate proton mobility. By applying an external anodic potential between the metal/WO₃ film and the electrolyte in direct contact with the WO₃ side, protons are driven by the electric field into the electrolyte. In the meantime, electrons flow away from the composite film via the external circuit. As a result, hydrogen atoms are oxidized to protons via the metal/WO₃ composite.

### Selectivity Towards Hydrogen Oxidation in the Presence of O₂

During hydrogen oxidation catalysis metal sites face towards the substrates and WO₃ towards the electrolyte in an exemplary configuration described here. Because the metal is separated from the electrolyte by WO₃, and WO₃ is inert for catalytic reactions (e.g., oxygen reduction), even if the electrolyte is saturated by O₂, it does not affect hydrogen activation on the metal sites. Thus, we can realize selective anode catalysis with the metal/WO₃ composite to facilitate the membrane-free fuel cell.

### Charge Separation and H-to-Proton Conversion

The metal/WO₃ configuration provides a platform to use electrochemistry to control the rate of catalysis. By altering the applied potential or current, we are able to modulate the rate of H-atom removal from the WO₃ membrane and the H-atom concentration intercalated in the WO₃. The H-atom concentration is proportional to the rate of hydrogen spillover, which is the rate-limiting step in hydrogen oxidation catalysis. Accordingly, we can modulate the rate of catalysis using electrochemistry.

### Utilizing Reversal of Hydrogen Spillover for Reductive Hydrogen Spillover

Upon applying a reductive potential across the metal/WO₃ composite, we can convert electrolyte protons to hydrogen atoms which are intercalated into WO₃. At the interface between metal and WO₃, hydrogen atoms migrate from WO₃ to the metal. When substrates such as alkenes, alkynes, oxygenates, carbonyls or CO₂, CO, etc. are supplied to the metal, the adsorbed hydrogen atoms reduce these substrates, thus realizing hydrogenation catalysis.

Metal oxides display proton and electron conductivity at room temperature and allow for electrochemically controlled cation intercalation—specifically proton intercalation. By combining such materials with metal catalysts (e.g., Pt, Pd) spillover of hydrogen atoms between the oxide and the metal catalyst can be exploited to electrochemically drive heterogeneous catalytic transformations.

Compared to the traditional heterogeneous catalysis, this configuration possesses a number of novel and surprising advantages. First, this design separates the metal sites from the electrolyte. It is well-documented that Pt and Pd are readily poisoned by electrolyte ions such as phosphate, and electrolyte-dissolved species such as O₂ and CO. The separation of metal active sites from the electrolyte eliminates this pathway to catalyst poisoning, thus improving the stability of the catalysts.

Additionally, in traditional electrocatalysis, especially for gaseous substrates, a gas-catalyst-electrolyte 3-phase boundary is required. Here, this 3-phase boundary is reduced to a 2-phase boundary by using a low-temperature mixed electronic-ionic conductor, leading to substantial improvements in catalyst accessibility and mass transport. Moreover, our technology allows for precise control of catalytic activity by modulating the transport of hydrogen atoms. For example, the applied electrochemical potential exclusively determines whether hydrogen atoms spill over from metal to oxides or vice versa, which drives the dehydrogenation or hydrogenation of substrate molecules. A benefit of eliminating the presence of pure dihydrogen in these reactions is the reduction of common side-reactions such as over-hydrogenation, hydrogenolysis, or back-hydrogenation in dehydrogenation processes.

The devices disclosed herein can catalyze a number of industrially important commodity conversions involving the transfer of hydrogen atoms. This includes hydrogen oxidation, methanol oxidation and formic acid oxidation which are anode reactions for fuel cells; alkane dehydrogenation generating alkenes which are precursors for higher order industrial products; carbon dioxide and carbon monoxide reduction to useful chemicals which have the potential to complete the renewable energy cycle. Further applications include the electrochemically-driven selective hydrogenation of petrochemicals and biofuel intermediates. These chemical conversions catalyzed by our composite heterogeneous catalyst at low temperature are attractive to the fuel cell industry, the fuel and petrochemical industries, and companies working on carbon capture and conversion.

In one aspect, the device comprises a porous support substrate, and a film in contact with the porous support substrate, wherein the film comprises:

a first oxide layer; and

an ionic conductor layer; wherein
the oxide is selected from the group consisting of WO₃, WO₂, MoO₃, MoO₂, TiO₂, TiO, ZnO, ZrO₂, ZrO, CeO₂, CeO, TiCeO₂, YCeO₂, carbon, V₂O₅, MoS₂, WS₂, NiOOH, MnO₂, SnO₂, Fe₂O₃, and CrOₓ, wherein x is a number from 0.1 to 3; and

the ionic conductor is selected from the group consisting of an electrolyte, a polymer membrane, and an inorganic compound.

In another aspect, the device comprises a porous support substrate, and a film in contact with the porous support substrate, wherein the film comprises:

a first catalyst layer;

a first oxide layer; and

an ionic conductor layer; wherein
the catalyst is selected from the group consisting of a metal, a metal nitride, a metal oxide, a metal sulfide, a metal carbide, Pt, Pd, Ru, Re, Co, Cu, Rh, CoMo, NiMo, NiW sulfide, Ni, Fe, and Au;
the oxide is selected from the group consisting of WO₃, WO₂, MoO₃, MoO₂, TiO₂, TiO, ZnO, ZrO₂, ZrO, CeO₂, CeO, TiCeO₂, YCeO₂, carbon, V₂O₅, MoS₂, WS₂, NiOOH, MnO₂, SnO₂, Fe₂O₃, and CrOₓ, wherein x is a number from 0.1 to 3; and
the ionic conductor is selected from the group consisting of an electrolyte, a polymer membrane, and an inorganic compound.

In yet another aspect, the device comprises a porous support substrate, and a film in contact with the porous support substrate, wherein the film comprises:

a first catalyst layer;

a first oxide layer;

an ionic conductor layer;

a second oxide layer; and

a second catalyst layer; wherein
each catalyst is independently selected from the group consisting of a metal, a metal nitride, a metal oxide, a metal sulfide, a metal carbide, Pt, Pd, Ru, Re, Co, Cu, Rh, Pt sulfide, Pd sulfide, Rh sulfide, CoMo sulfide, NiMo sulfide, NiW sulfide, Ni, Fe, and Au;
the oxide is selected from the group consisting of WO₃, WO₂, MoO₃, MoO₂, TiO₂, TiO, ZnO, ZrO₂, ZrO, CeO₂, CeO, TiCeO₂, YCeO₂, carbon, V₂O₅, MoS₂, WS₂, NiOOH, MnO₂, SnO₂, Fe₂O₃, and CrOₓ, wherein x is a number from 0.1 to 3; and
the ionic conductor is selected from the group consisting of an electrolyte, a polymer membrane, and an inorganic compound.

In certain embodiments, x is 1. In other embodiments, x is 2. In yet other embodiments, x is 3.

In one aspect, the device comprises a porous support substrate, and a film in contact with the porous support substrate, wherein the film comprises:

a first oxide layer; and

an ionic conductor layer; wherein
the oxide is selected from the group consisting of WO₃, MoO₃, TiO₂, ZnO, ZrO₂, CeO₂, TiCeO₂, YCeO₂, carbon, V₂O₅, MoS₂, WS₂, NiOOH, MnO₂, SnO₂, Fe₂O₃, and CrOₓ, wherein x is a number from 0.1 to 3; and
the ionic conductor is selected from the group consisting of an electrolyte, a polymer membrane, and an inorganic compound.

In another aspect, the device comprises a porous support substrate, and a film in contact with the porous support substrate, wherein the film comprises:

a first catalyst layer;

a first oxide layer; and

an ionic conductor layer; wherein
the catalyst is selected from the group consisting of a metal, a metal nitride, a metal oxide, a metal sulfide, a metal carbide, Pt, Pd, Ru, Re, Co, Cu, Rh, CoMo, NiMo, NiW sulfide, Ni, Fe, and Au;
the oxide is selected from the group consisting of WO₃, MoO₃, TiO₂, ZnO, ZrO₂, CeO₂, TiCeO₂, YCeO₂, carbon, V₂O₅, MoS₂, WS₂, NiOOH, MnO₂, SnO₂, Fe₂O₃, and CrOₓ, wherein x is a number from 0.1 to 3; and
the ionic conductor is selected from the group consisting of an electrolyte, a polymer membrane, and an inorganic compound.

In yet another aspect, the device comprises a porous support substrate, and a film in contact with the porous support substrate, wherein the film comprises:

a first catalyst layer;

a first oxide layer;

an ionic conductor layer;

a second oxide layer; and

a second catalyst layer; wherein
each catalyst is independently selected from the group consisting of a metal, a metal nitride, a metal oxide, a metal sulfide, a metal carbide, Pt, Pd, Ru, Re, Co, Cu, Rh, Pt sulfide, Pd sulfide, Rh sulfide, CoMo sulfide, NiMo sulfide, NiW sulfide, Ni, Fe, and Au;
each oxide is independently selected from the group consisting of WO₃, MoO₃, TiO₂, ZnO, ZrO₂, CeO₂, TiCeO₂, YCeO₂, carbon, V₂O₅, MoS₂, WS₂, NiOOH, MnO₂, SnO₂, Fe₂O₃, and CrOₓ, wherein x is a number from 0.1 to 3; and the ionic conductor is selected from the group consisting of an electrolyte, a polymer membrane, and an inorganic compound.

In certain embodiments, the porous support substrate has a thickness of about 10 μm, about 11 μm, about 12 μm, about 13 μm, about 14 μm, about 15 μm, about 16 μm, about 17 μm, about 18 μm, about 19 μm, about 20 μm, about 22 μm, about 24 μm, about 26 μm, about 28 μm, about 30 μm, about 32 μm, about 34 μm, about 36 μm, about 38 μm, about 40 μm, about 42 μm, about 44 μm, about 46 μm, about 48 μm, or about 50 μm. In certain embodiments, the porous support substrate has a thickness of about 15 μm.

In certain embodiments, the pores of the porous support substrate have an average diameter of about 50 nm, about 100 nm, about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 950 nm, or about 1,000 nm. In certain embodiments, the pores of the porous support substrate have an average diameter of about 50 nm, about 100 nm, about 150 nm, about 200 nm, about 250 nm, about 300 nm, about 350 nm, about 400 nm, about 450 nm, or about 500 nm. In certain embodiments, the pores of the porous support substrate have an average diameter of about 200 nm.

In certain embodiments, the porous support substrate is hydrophilic. In certain embodiments, the porous support substrate is a polymer, a ceramic, a metal salt, a metal, or a non-metal. In certain embodiments, the polymer is a polycarbonate, polybenzimidazole, a polystyrene, a polyurethane, cellulose, a polyvinyl chloride, or latex. In certain embodiments, polymer is a polycarbonate membrane. In certain embodiments, the ceramic is Al₂O₃, TiO₂, ZrO₂, or yttria-stabilized zirconia. In certain embodiments, the metal salt is calcium phosphate. In certain embodiments, the metal is stainless steel, titanium, or silicon. In certain embodiments, the non-metal is carbon.

In certain embodiments, the first catalyst layer is Pt or Pd and the first oxide layer is WO₃. In certain embodiments, the first catalyst layer is Pt or Pd and the first oxide layer is WO₂. In certain embodiments, the first catalyst layer is Pt or Pd and the first oxide layer is MoO₃. In certain embodiments, the first catalyst layer is Pt or Pd and the first oxide layer is MoO₂. In certain embodiments, the first catalyst layer is Rh and the first oxide layer is TiO₂. In certain embodiments, the first catalyst layer is Rh and the first oxide layer is TiO.In certain embodiments, the first catalyst layer is Cu and the first oxide layer is ZnO. In certain embodiments, the first catalyst layer is Pt or Rh and the first oxide layer is CeO₂. In certain embodiments, the first catalyst layer is Pt or Rh and the first oxide layer is CeO. In certain embodiments, the first catalyst layer is Pd and the first oxide layer is TiCeO₂. In certain embodiments, the first catalyst layer is Fe, Co, Ni, or Cu, and the first oxide layer is TiCeO₂. In certain embodiments, the first catalyst layer is Fe, Ru or Re, and the first oxide layer is TiCeO₂. In certain embodiments, the first catalyst layer is Ni and the first oxide layer is TiCeO₂. In certain embodiments, the first catalyst layer is Pd and the first oxide layer is YCeO₂. In certain embodiments, the first catalyst layer is Fe, Co, Ni, or Cu, and the first oxide layer is YCeO₂. In certain embodiments, the first catalyst layer is Fe, Ru or Re, and the first oxide layer is YCeO₂. In certain embodiments, the first catalyst layer is Pt and the first oxide layer is carbon. In certain embodiments, the first catalyst layer is Pt or Pd and the first oxide layer is V205. In certain embodiments, the first catalyst layer is Pt sulfide, Pd sulfide, Rh sulfide, CoMo sulfide, NiMo sulfide, or NiW sulfide, and the first oxide layer is MoS₂. In certain embodiments, the first catalyst layer is Pt sulfide, Pd sulfide, Rh sulfide, CoMo sulfide, NiMo sulfide, or NiW sulfide, and the first oxide layer is WS₂. In certain embodiments, the first catalyst layer is Pd, and the first oxide layer is NiOOH. In certain embodiments, the first catalyst layer is Pd or Pt, and the first oxide layer is MnO₂. In certain embodiments, the first catalyst layer is Pd or Pt, and the first oxide layer is SnO₂. In certain embodiments, the first catalyst layer is Sn, and the first oxide layer is SnO₂. In certain embodiments, the first catalyst layer is Fe, Co, Ni, or Cu, and the first oxide layer is SnO₂. In certain embodiments, the first catalyst layer is Fe, Ru, or Re, and the first oxide layer is SnO₂. In certain embodiments, the first catalyst layer is Pt, and the first oxide layer is Fe₂O₃. In certain embodiments, the first catalyst layer is Au, and the first oxide layer is Fe₂O₃. In certain embodiments, the first catalyst layer is Pt, and the first oxide layer is CrOₓ. In certain embodiments, the first oxide layer is CrOₓ or Fe₂O₃. In certain embodiments, the first catalyst layer is Rh and the first oxide layer is ZrO₂. In certain embodiments, the first catalyst layer is Rh and the first oxide layer is ZrO.

In certain embodiments, the second catalyst layer is Pt or Pd and the second oxide layer is WO₃. In certain embodiments, the second catalyst layer is Pt or Pd and the second oxide layer is WO₂. In certain embodiments, the second catalyst layer is Pt or Pd and the second oxide layer is MoO₃. In certain embodiments, the second catalyst layer is Pt or Pd and the second oxide layer is MoO₂. In certain embodiments, the second catalyst layer is Rh and the second oxide layer is TiO₂. In certain embodiments, the second catalyst layer is Rh and the second oxide layer is TiO. In certain embodiments, the second catalyst layer is Cu and the second oxide layer is ZnO. In certain embodiments, the second catalyst layer is Pt or Rh and the second oxide layer is CeO₂. In certain embodiments, the second catalyst layer is Pt or Rh and the second oxide layer is CeO. In certain embodiments, the second catalyst layer is Pd and the second oxide layer is TiCeO₂. In certain embodiments, the second catalyst layer is Fe, Ru or Re, and the second oxide layer is TiCeO₂. In certain embodiments, the second catalyst layer is Ni and the second oxide layer is TiCeO₂. In certain embodiments, the second catalyst layer is Pd and the second oxide layer is YCeO₂. In certain embodiments, the second catalyst layer is Fe, Co, Ni, or Cu, and the second oxide layer is YCeO₂. In certain embodiments, the second catalyst layer is Fe, Ru or Re, and the second oxide layer is YCeO₂. In certain embodiments, the second catalyst layer is Pt and the second oxide layer is carbon. In certain embodiments, the second catalyst layer is Pt or Pd and the second oxide layer is V₂O₅. In certain embodiments, the second catalyst layer is Pt sulfide, Pd sulfide, Rh sulfide, CoMo sulfide, NiMo sulfide, or NiW sulfide, and the second oxide layer is MoS₂. In certain embodiments, the second catalyst layer is Pt sulfide, Pd sulfide, Rh sulfide, CoMo sulfide, NiMo sulfide, or NiW sulfide, and the second oxide layer is WS₂. In certain embodiments, the second catalyst layer is Pd, and the second oxide layer is NiOOH. In certain embodiments, the second catalyst layer is Pd or Pt, and the second oxide layer is MnO₂. In certain embodiments, the second catalyst layer is Pd or Pt, and the second oxide layer is SnO₂. In certain embodiments, the second catalyst layer is Sn, and the second oxide layer is Sn₂. In certain embodiments, the second catalyst layer is Fe, Co, Ni, or Cu, and the second oxide layer is SnO₂. In certain embodiments, the second catalyst layer is Fe, Ru, or Re, and the second oxide layer is SnO₂. In certain embodiments, the second catalyst layer is Pt, and the second oxide layer is Fe₂O₃. In certain embodiments, the second catalyst layer is Au, and the second oxide layer is Fe₂O₃. In certain embodiments, the second catalyst layer is Pt, and the second oxide layer is CrOₓ. In certain embodiments, the second catalyst layer is Rh and the second oxide layer is ZrO₂. In certain embodiments, the second catalyst layer is Rh and the second oxide layer is ZrO.

In certain embodiments, x is an integer from 0.1-3 (e.g., 1, 2, or 3). In other embodiments, x is non-integer number from 0.1-3 (e.g., 0.5, 1.25, 1.5, 2.3, 2.7).

In certain embodiments, the first catalyst layer has a thickness of about 1 nm, about 2 nm, about 3 nm, about 4 nm, about 5 nm, about 6 nm, about 7 nm, about 8 nm, about 9 nm, or about 10 nm, about 25 nm, about 50 nm, about 75 nm, about 100 nm, about 125 nm, about 150 nm, about 175 nm, about 200 nm, about 225 nm, about 250 nm, about 275 nm, about 300 nm, about 325 nm, about 350 nm, about 375 nm, about 400 nm, about 425 nm, about 450 nm, about 475 nm, or about 500 nm. In certain embodiments, the first catalyst layer has a thickness of about 1 nm, about 2 nm, about 3 nm, about 4 nm, about 5 nm, about 6 nm, about 7 nm, about 8 nm, about 9 nm, or about 10 nm. In certain embodiments, the first catalyst layer has a thickness of about 5 nm.

In certain embodiments, the second catalyst layer has a thickness of about 1 nm, about 2 nm, about 3 nm, about 4 nm, about 5 nm, about 6 nm, about 7 nm, about 8 nm, about 9 nm, about 10 nm, about 25 nm, about 50 nm, about 75 nm, about 100 nm, about 125 nm, about 150 nm, about 175 nm, about 200 nm, about 225 nm, about 250 nm, about 275 nm, about 300 nm, about 325 nm, about 350 nm, about 375 nm, about 400 nm, about 425 nm, about 450 nm, about 475 nm, or about 500 nm. In certain embodiments, the second catalyst layer has a thickness of about 1 nm, about 2 nm, about 3 nm, about 4 nm, about 5 nm, about 6 nm, about 7 nm, about 8 nm, about 9 nm, or about 10 nm. In certain embodiments, the second catalyst layer has a thickness of about 5 nm.

In certain embodiments, the first oxide layer has a thickness of about 0.5 μm, about 1μm, about 1.5 μm, about 2.0 μm, about 2.5 μm, about 5μm, about 7.5 μm, about 10 μm, about 12.5 μm, or about 15 μm. In certain embodiments, the first oxide layer has a thickness of about 1μm.

In certain embodiments, the second oxide layer has a thickness of about 0.5 μm, about 1 μm, about 1.5 μm, about 2.0 μm, about 2.5 μm, about 5μm, about 7.5 μm, about 10 μm, about 12.5 μm, or about 15 μm. In certain embodiments, the second oxide layer has a thickness of about 1 μm.

In certain embodiments, the film is deposited upon the porous support substrate by magnetron sputtering, thermal evaporation, e-beam evaporation, spray pyrolysis, doctor blade deposition, atomic-layer deposition, or electrodeposition. In certain embodiments, the film is deposited upon the porous support substrate by magnetron sputtering.

In certain embodiments, the electrolyte is an aqueous electrolyte. In certain embodiments, the aqueous electrolyte is an acidic solution, a neutral solution, or a basic solution. In certain embodiments, the aqueous electrolyte comprises NaClO₄. In certain embodiments, the aqueous electrolyte is an acidic solution. In certain embodiments, the aqueous electrolyte comprises HClO₄.

In other embodiments, the electrolyte is a non-aqueous electrolyte. In certain embodiments, the non-aqueous electrolyte is protic or aprotic. In certain embodiments, the non-aqueous electrolyte is an alcohol, an ether, an acetate, a carboxylic acid, a nitrile, a formamide, an acetamide, a sulfoxide, a halogenated hydrocarbon, a ketone, or a non-aqueous acid. In certain embodiments, the non-aqueous electrolyte is N-methylpyrrolidone, dimethylcarbonate, ethyl methyl carbonate, propylene carbonate, phosphoric acid, ethylene carbonate, acetonitrile, methanol, ethanol, propanol, butanol, isopropanol, acetic acid, trifluoroactic acid, butanoic acid, propanoic acid, dimethyl formamide, dimethylacetatemide, dimethyl sulfoxide, tetrahydrofuran, methyltetrahydrofuran, dichloromethane, trichloroethane, tetrachloromethane, dichloroethane, ethyl acetate, methyl acetate, propyl acetate, or acetone.

In certain embodiments, the inorganic compound is cesium hydrogen sulfate, cesium dihydrogen phosphate, aluminum oxide, or a cerate perovskite (e.g., strontium cerate perovskite).

In certain embodiments, the polymer membrane is a sulfonated tetrafluoroethylene based fluoropolymer-copolymer (e.g., Nafion). In certain embodiments, the polymer is tetrafluoroethylene-perfluoro-3,6-dioxa-4-methyl-7-octenesulfonic acid copolymer

### Exemplary Methods of Use

Generally, the described transformations can be performed by any of the devices disclosed herein. For example, in certain embodiments, the transformation(s) can be performed by a device comprising one or more oxide layer(s) and one or more catalyst layer(s). In other embodiments, the transformation(s) can be performed by device comprising one or more oxide layer(s) and one or more ionic conductor layer(s) (e.g., in certain embodiments, the ionic conductor layer is both an ionic conductor and a catalyst, or in certain embodiments, the oxide is the catalyst).

In certain aspects, the present disclosure provides methods of using the aforementioned devices to perform chemical transformations.

In certain embodiments, the present disclosure provides a method of hydrogen oxidation, comprising the steps of:

contacting a device disclosed herein with a source of hydrogen, thereby forming a reaction mixture; and

applying an electrical potential to the reaction mixture.

In certain embodiments, the present disclosure provides a method of hydrogen pumping, comprising the steps of:

contacting a device disclosed herein with a source of hydrogen, thereby forming a

reaction mixture; and

applying an electrical potential to the reaction mixture.

In certain embodiments, the present disclosure provides a method of formic acid dehydrogenation, comprising the steps of:

contacting a device disclosed herein with a source of formic acid, thereby forming a reaction mixture; and

applying an electrical potential to the reaction mixture.

In certain embodiments, the present disclosure provides a method of methanol dehydrogenation, comprising the steps of:

contacting a device disclosed herein with a source of methanol, thereby forming a reaction mixture; and

applying an electrical potential to the reaction mixture.

In certain embodiments, the present disclosure provides a method of alkene hydrogenation, comprising the steps of:

contacting a device disclosed herein with an alkene and a source of hydrogen, thereby forming a reaction mixture; and

applying an electrical potential to the reaction mixture.

In certain embodiments, the present disclosure provides a method of forming a carbon-carbon bond, comprising the steps of:

contacting a device disclosed herein with a first carbon substrate and a second carbon substrate, thereby forming a reaction mixture; and

applying an electrical potential to the reaction mixture.

In certain embodiments, the present disclosure provides a method of silane coupling, comprising the steps of:

contacting a device disclosed herein with a first silane substrate and a second silane substrate, thereby forming a reaction mixture; and

applying an electrical potential to the reaction mixture.

In certain embodiments, the present disclosure provides a method of producing a hydrocarbon, comprising the steps of:

contacting a device disclosed herein with a source of carbon monoxide and a source of hydrogen, thereby forming a reaction mixture; and

applying an electrical potential to the reaction mixture.

In certain embodiments, the present disclosure provides a method of reducing diatomic nitrogen, comprising the steps of:

contacting a device disclosed herein with a source of diatomic nitrogen and a source of hydrogen, thereby forming a reaction mixture; and

applying an electrical potential to the reaction mixture.

In certain embodiments, the present disclosure provides a method of producing hydrogen and carbon monoxide, comprising the steps of

contacting a device disclosed herein with a source of methane and a source of water, thereby forming a reaction mixture; and

applying an electrical potential to the reaction mixture.

In certain embodiments, the present disclosure provides a method of carbon dioxide hydrogenation, comprising the steps of

contacting a device disclosed herein with a source of carbon dioxide and a source of hydrogen, thereby forming a reaction mixture; and

applying an electrical potential to the reaction mixture.

In certain embodiments, the present disclosure provides a method of producing hydrogen, comprising the steps of

contacting a device of the disclosure with a source of water, thereby forming a reaction mixture; and

applying an electrical potential to the reaction mixture.

In certain embodiments, the present disclosure provides a method of producing methanol, comprising the steps of

contacting a device disclosed herein with a source of carbon dioxide, thereby forming a reaction mixture; and

applying an electrical potential to the reaction mixture.

In certain embodiments, the present disclosure provides a method of isomerizing an alkane, comprising the steps of

contacting a device disclosed herein with an alkane, thereby forming a reaction mixture; and

applying an electrical potential to the reaction mixture.

In certain embodiments, the present disclosure provides a method of oxygen reduction, comprising the steps of

contacting a device disclosed herein with a source of oxygen, thereby forming a reaction mixture; and

applying an electrical potential to the reaction mixture.

In certain embodiments, the present disclosure provides a method of cracking methane, comprising the steps of

contacting a device disclosed herein with a source of methane, thereby forming a reaction mixture; and

applying an electrical potential to the reaction mixture.

In certain embodiments, the present disclosure provides a method of producing carbon dioxide and hydrogen, comprising the steps of

contacting a device disclosed herein with a source of carbon monoxide and a source of water, thereby forming a reaction mixture; and

applying an electrical potential to the reaction mixture.

In certain embodiments, the present disclosure provides a method of hydrodesulfurization, comprising the steps of

contacting a device disclosed herein with a sulfur containing substrate and a source of hydrogen, thereby forming a reaction mixture; and

applying an electrical potential to the reaction mixture.

In certain embodiments, the present disclosure provides a method of hydrodenitrogenation, comprising the steps of

contacting a device disclosed herein with a nitrogen containing substrate and a source of hydrogen, thereby forming a reaction mixture; and

applying an electrical potential to the reaction mixture.

In certain embodiments, the present disclosure provides a method of carbon monoxide oxidation, comprising the steps of

contacting a device disclosed herein with a source of carbon monoxide and a source of oxygen, thereby forming a reaction mixture; and

applying an electrical potential to the reaction mixture.

In certain embodiments, the present disclosure provides a method of ketone hydrogenation, comprising the steps of

contacting a device disclosed herein with a ketone and a source of hydrogen, thereby forming a reaction mixture; and

applying an electrical potential to the reaction mixture.

In certain embodiments, the present disclosure provides a method of dehydrogenation, comprising the steps of

contacting a device disclosed herein with a hydrogen containing substrate, thereby forming a reaction mixture; and

applying an electrical potential to the reaction mixture.

In certain embodiments, the present disclosure provides a method of hydrogen, comprising the steps of

contacting a device disclosed herein with hydrogen and a hydrogen storage medium, thereby forming a reaction mixture; and

applying an electrical potential to the reaction mixture.

In certain embodiments, the chemical transformations are carried out using the catalyst and oxide pairings disclosed in Table 1.

TABLE 1
Exemplary metal catalyst and metal oxide combinations
for certain chemical transformations

| Chemical Transformation | Catalyst | Metal Oxide |
|---|---|---|
| Hydrogen oxidation, hydrogen | Pt, Pd | WO₃ or WO₂ |
| pumping, formic acid | | |
| dehydrogenation, methanol | | |
| dehydrogenation, alkene | | |
| hydrogenation, cyclohexene | | |
| hydrogenation/dehydrogenation, | | |
| carbon carbon bond formation, or | | |
| silane coupling | | |
| Hydrocarbon synthesis | Fe, Co, Ni, Cu | WO₃, WO₂, |
| | | MoO₃, MoO₂, |
| | | TiCeO₂, |
| | | YCeO₂, or SnO₂ |
| Reduction of diatomic nitrogen | Fe, Ru, Re | WO₃, WO₂, |
| | | MoO₃, MoO₂, |
| | | TiCeO₂, |
| | | YCeO₂, or SnO₂ |
| Hydrogen and carbon monoxide | Ni | WO₃, WO₂, |
| production | | MoO₃, or MoO₂ |
| Hydrogen oxidation or alkene | Pt, Pd | MoO₃ or MoO₂, |
| hydrogenation | | |
| Carbon dioxide hydrogenation or | Rh | TiO₂ or TiO |
| hydrogen evolution | | |
| Hydrogen evolution | Pt | TiO₂ or TiO |
| Methanol steam reforming | Pd, Cu | ZnO, ZrO₂, or |
| | | ZrO |
| Methanol synthesis. | Cu | ZnO, ZrO₂, or |
| | | ZrO |
| Alkane hydroisomerization | Pt | ZrO₂ or ZrO |
| Oxygen reduction or methane | Pt, Pd, or Rh | CeO₂, CeO, or |
| cracking (oxygen spillover) | | MnO₂ |
| Water gas shift reaction | Pt and PtAu | CeO₂ or CeO |
| Hydrogen oxidation, hydrogen | Pd | TiCeO₂ or |
| pumping, or methane oxidation. | | YCeO₂ |
| Methane reforming | Ni | TiCeO₂, |
| | | YCeO₂, or SnO₂ |
| Hydrogen oxidation or hydrogen | Pt | Carbon |
| storage | | |
| Hydrogen oxidation or ethene | Pt and Pd | V₂O₅ |
| hydrogenation | | |
| hydrodesulfurisation of thiophenes, | Pt, Pd, Rh, CoMo, | MoS₂, WS₂ |
| general hydrogen desulfurization, | NiMo, and NiW | |
| or hydrodenitrogenation | sulfides | |
| Hydrogen oxidation or carbon | Pt or Pd | SnO₂ |
| monoxide CO oxidation | | |
| Carbon dioxide hydrogenation | Sn | SnO₂ |
| Hydrogen oxidation or oxygen | Pt | Fe₂O₃ |
| reduction | | |
| Ketone hydrogenation or CO | Au | Fe₂O₃ |
| oxidation (oxygen spillover) | | |
| Dehydrogenation | Pt | CrOx |
| Dehydrogenation | None (i.e., | CrOx, Fe₂O₃ |
| | the oxide is | |
| | the catalyst) | |

In certain embodiments, the electrical potential is applied in a cyclic manner (e.g., cyclic voltammetry), a constant manner (e.g., linear sweep voltammetry, chronoamperometry, or chronogalvanometry). In certain embodiments, the electrical potential is applied in a cyclic manner (i.e., cyclic voltammetry).

In certain embodiments, the electrical potential is applied in a range from about −2.0 V, about −1.9 V, about −1.8 V, about −1.7 V, about −1.6 V, about −1.5 V, about −1.4 V, about −1.3 V, about −1.2 V, about −1.1 V, about −1.0 V, about −0.9 V, about −0.8 V, about −0.7 V, about −0.6 V, about −0.5 V, about −0.4 V, about −0.3 V, about −0.2 V, about −0.1 V, or about 0 V to about 0.1 V, about 0.2 V, about 0.3 V, about 0.4 V, about 0.5 V, about 0.6 V, about 0.7 V, about 0.8 V, about 0.9 V, about 1.V, about 1.1 V, about 1.2 V, about 1.3 V, about 1.4 V, about 1.5 V, about 1.6 V, about 1.7 V, about 1.8 V, about 1.9 V, or about 2.0 V. In certain embodiments, the electrical potential is applied in a range from about 0 V to about 0.5 V.

In certain embodiments, the electrical potential is modulated at a rate of about 5 mV s⁻¹, about 10 mV s⁻¹, about 15 mV s⁻¹, about 20 mV s⁻¹, about 25 mV s⁻¹, about 30 mV s⁻¹, about 35 mV s⁻¹, about 40 mV s⁻¹, about 45 mV s⁻¹, about 50 mV s⁻¹, about 55 mV s⁻¹, about 60 mV s⁻¹, about 65 mV s⁻¹, about 70 mV s⁻¹, about 75 mV s⁻¹, about 80 mV s⁻¹, about 85 mV s⁻¹, about 90 mV s⁻¹, about 95 mV s⁻¹, or about 100 mV s⁻¹. In certain embodiments, the electrical potential is modulated at a rate of about 50 mV s⁻¹.

In certain embodiments, the electrical current is applied in a cyclic manner (e.g., cyclic voltammetry or linear sweep voltammetry). In certain embodiments, the electrical current is applied in a constant manner (e.g., chronoamperometry, or chronogalvanometry).

In certain embodiments, the methods disclose herein further comprise contacting the reaction mixture with a reference electrode. In certain embodiments, the reference electrode is a Mercury-mercurous sulfate electrode.

In certain embodiments, the methods disclose herein further comprise contacting the reaction mixture with a counter electrode. In certain embodiments, the counter electrode is a platinum electrode.

In certain embodiments, the methods disclose herein further comprise increasing or decreasing the temperature of the reaction mixture. In certain embodiments, the methods comprises increasing the temperature of the reaction mixture. In certain embodiments, the methods comprises decreasing the temperature of the reaction mixture.

### Definitions

Unless otherwise defined herein, scientific and technical terms used in this application shall have the meanings that are commonly understood by those of ordinary skill in the art. Generally, nomenclature used in connection with, and techniques of chemistry are those well known and commonly used in the art.

Chemistry terms used herein, unless otherwise defined herein, are used according to conventional usage in the art, as exemplified by “The McGraw-Hill Dictionary of Chemical Terms”, Parker S., Ed., McGraw-Hill, San Francisco, Calif. (1985).

As used herein, the terms “optional” or “optionally” mean that the subsequently described event or circumstance may occur or may not occur, and that the description includes instances where the event or circumstance occurs as well as instances in which it does not. For example, “optionally substituted alkyl” refers to the alkyl may be substituted as well as where the alkyl is not substituted.

### EXAMPLES

The invention now being generally described, it will be more readily understood by reference to the following examples which are included merely for purposes of illustration of certain aspects and embodiments of the present invention, and are not intended to limit the invention.

### Example 1

### Preparation of Exemplary Compounds

A metal/WO₃ film can be fabricated in a large variety of ways. For example, WO₃ can be deposited on a porous substrate which supports the film. The substrate should be easy to handle with, compatible with the metal and WO₃, and stable when in contact with the electrolyte. More importantly, the substrate should be porous so that the electrolyte contacts the WO₃ film. The substrate pore size in that the pores should be large enough to allow water to enter, but should not be too large to deposit a pinhole-free film of WO₃ (e.g., 50-500 nm). Additionally, the substrate cannot be too thin, or it will be too fragile to work with; it cannot be too thick either, or the transport of protons through the pores will become difficult. Taking all of the factors into consideration, we chose hydrophilic porous polycarbonate membranes with 200 nm-diameter pore and 15 μm-thickness as our substrates.

### Fabrication of Metal/WO₃ Film

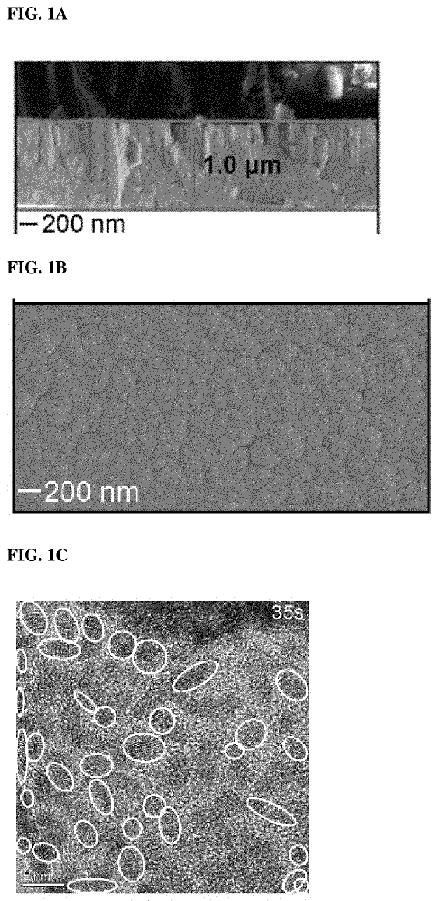

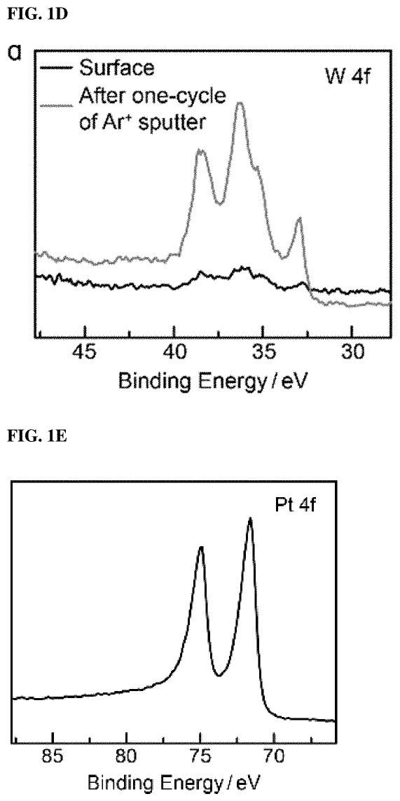

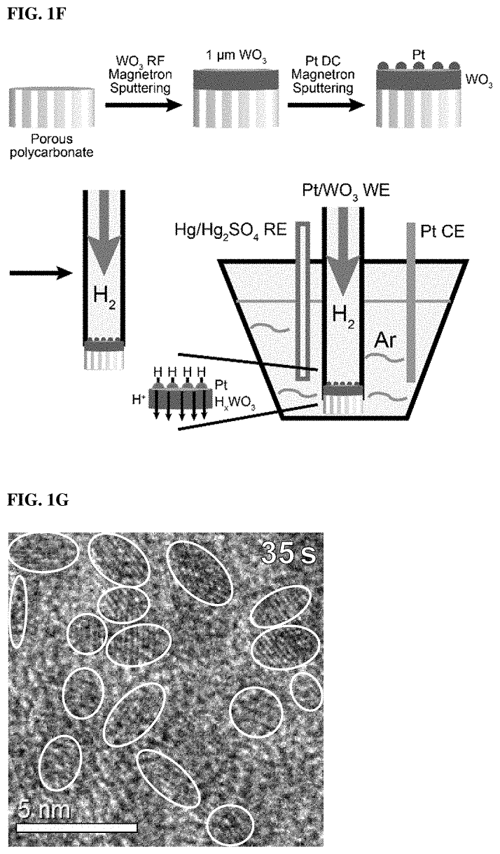

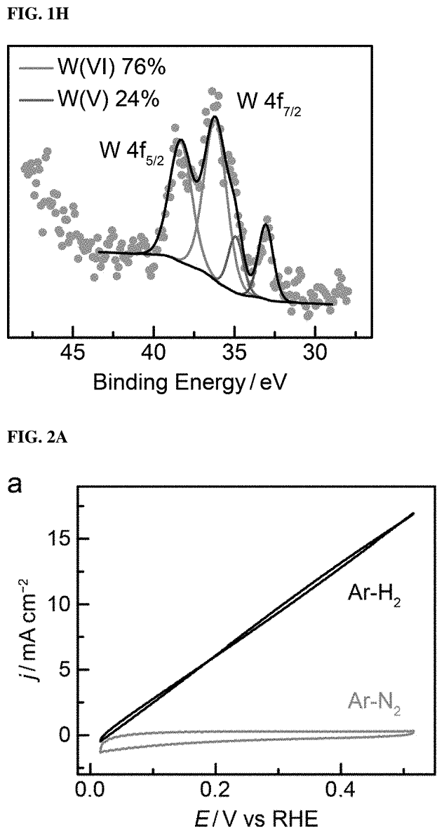

Magnetron sputtering was adopted as one of many possible methods to deposit metal and WO₃ films on polycarbonate substrates. For WO₃ deposition, we performed reactive RF sputter with W target in Ar and O₂ plasma. The thickness of deposited WO₃ is approximately 1.0 μm. As a metal catalyst, for example, approximately 5 nm platinum were deposited on WO₃ by DC sputtering. The films were characterized by top-down and cross-section scanning electron micrography (SEM) (FIGS. 1A and 1B). No pinholes or cracks were observed. We also deposited Pt and thin WO₃ films on Cu/lacey carbon grids to study the Pt morphology by transmission electron micrography (TEM) (FIG. 1C). X-ray photoelectron spectroscopy (XPS) confirmed the presence of W(VI), W(V) (FIG. 1D) and metallic Pt (FIG. 1E). FIG. 1F illustrates the fabrication process.

Another exemplary method of preparing WO₃ films is thermal evaporation. The rate of thermal evaporation deposition is 1-2 angstrom/s. The WO₃ films deposited by thermal evaporation exhibit cracks and defects. Therefore, we sinter the as-prepared films at 500° C. in 5% H₂/95% Ar for 3 h to minimize the population of cracks and defects. The resulting WO₃ films are rougher than the films prepared by magnetron sputtering. We compared the catalytic activity of the WO₃ films of different roughness factors.

### Assembly of Working Electrode From Metal/WO₃ Composite Films

The metal/WO₃ composite films need to be electrically contacted to enable electrochemical operation. Again, various methods can be used to achieve this. As an example, we applied silver paste around a piece of ¼″-diameter polycarbonate-supported metal/WO₃ film on the metal side, and then attached the sample to one end of a 5″-long graphite tube with the metal side facing the interior of the tube. The whole setup was used as the working electrode and the substrate was directly supplied into the graphite tube. By employing a reference and counter electrode in the electrolyte, electrochemical measurements were performed. The configuration is illustrated in FIG. 1F.

### Pt/WO₃ Catalyzing H2-to-Proton Conversion

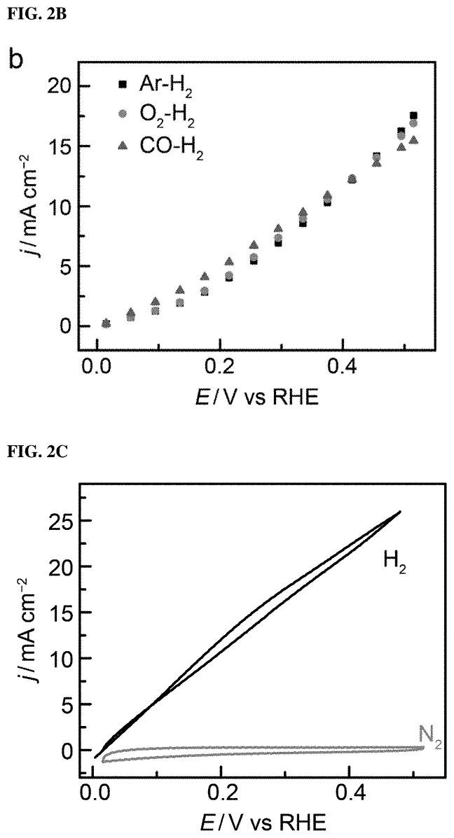

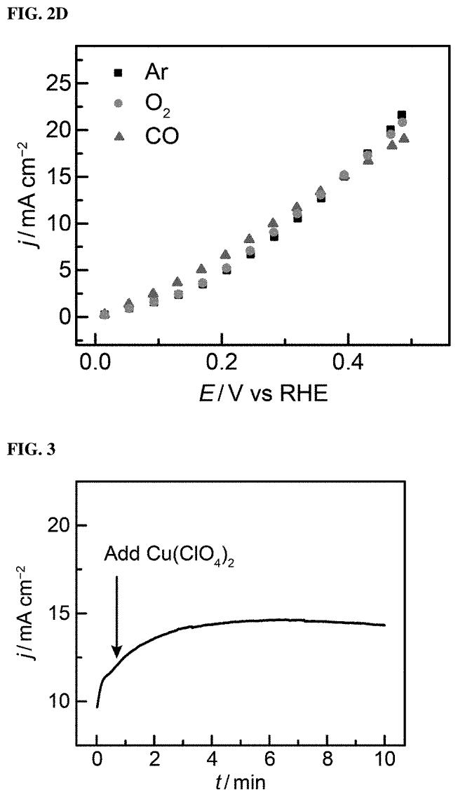

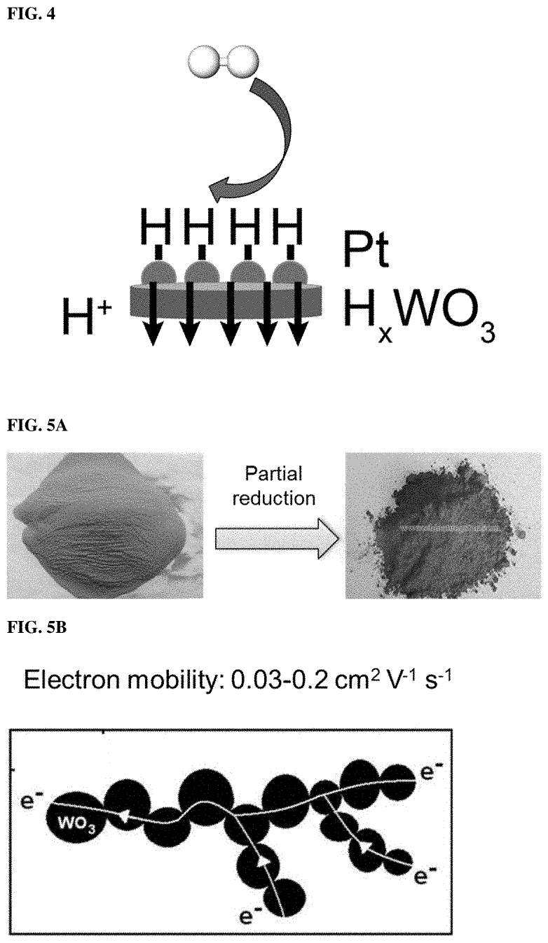

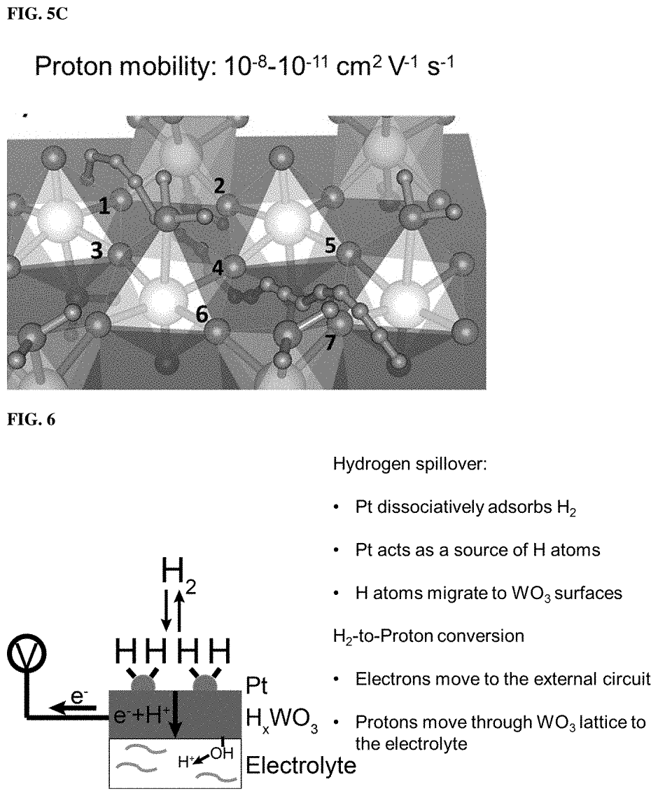

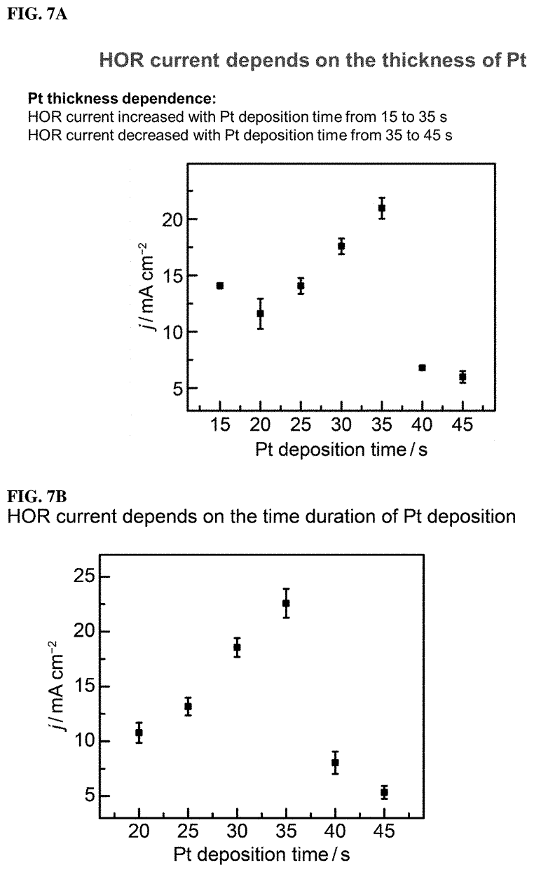

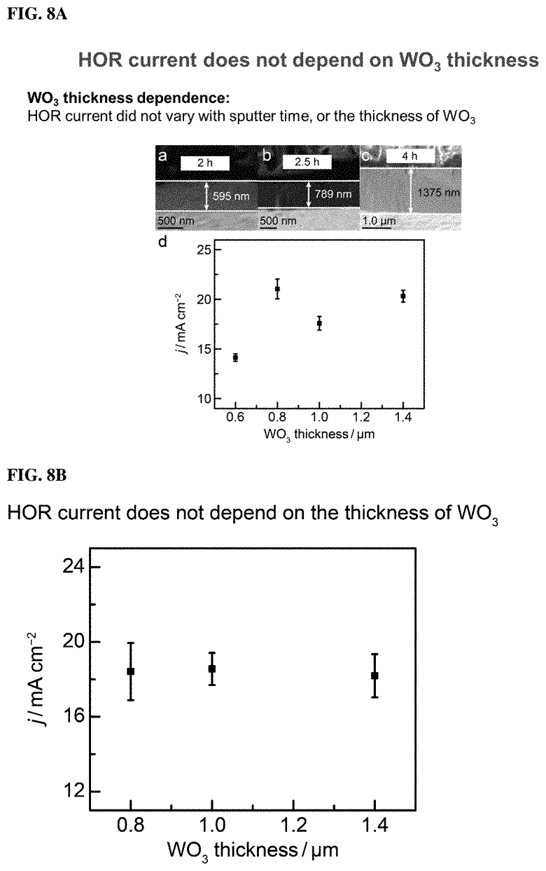

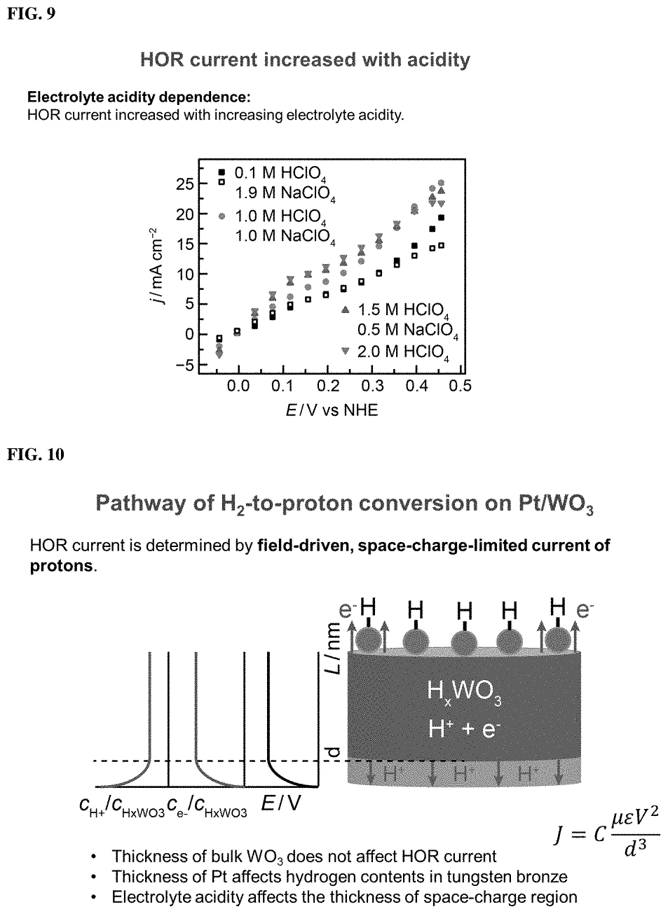

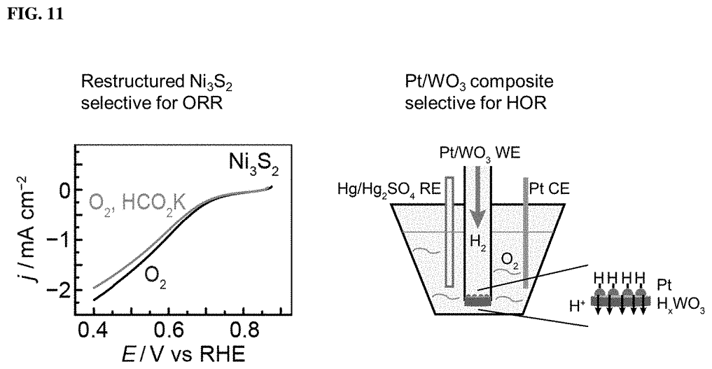

We tested the catalytic activity of the Pt/WO₃ electrode for hydrogen oxidation reaction. The electrolyte was 0.1 M HClO₄, pH 1.0. We first supplied 1 atm of N₂ to the working electrode and continuously purged the electrolyte with Ar. We left the electrode in the electrolyte for 15 min to wet the polycarbonate substrate. The uncompensated resistance was about 30Ω. Then we performed cyclic voltammetry measurement from 0.02 V to 0.52 V at 50 mV s⁻¹ sweep rate. We only observed double-layer capacitance current (FIG. 2A, bottom line), characterized by a flat CV trace. We then switched to 1 atm of H₂ supply to the working electrode, and observed an anodic current, confirming that the anodic current is due to H₂ oxidation (FIG. 2A, top line). We also performed chronoamperometry measurements to collect steady-state current by applying potentials from 0.02 V to 0.52 V at 40 mV intervals. The current density reaches a value in excess of 25 mA cm-2, which is 8-fold higher than the diffusion-limited rate of HOR catalysis if the Pt catalysts were directly exposed to the electrolyte. The steady-state current density versus potential data are plotted in FIG. 2B (squares).

### Pt/WO₃ Tolerance to Electrolyte Impurities

We then purged the electrolyte with O₂ instead of Ar to check the selectivity of HOR of the Pt/WO₃ composite in the presence of O₂ in the electrolyte. The chronoamperometry data displayed very similar HOR activity to those under Ar-saturated condition (FIG. 2B, circles), suggesting negligible influence of the dissolved O₂ in the electrolyte.

To further confirm the resistance of the Pt/WO₃ electrode to dissolved gases in the electrolyte, we used CO as a more stringent probe due to the strong adsorption of CO to Pt surfaces. If carbon monoxide can pass through pinholes of the WO₃ film and reach the Pt side, the HOR activity of the composite would decrease dramatically. Indeed, the chronoamperometry data under potentials from 0.02 V to 0.52 V overlay with the ones collected in Ar-saturated electrolyte (FIG. 2B, triangles), suggesting that the Pt/WO₃ is not poisoned by carbon monoxide dissolved in the electrolyte.

Besides the dissolved gaseous species, the Pt/WO₃ electrode also tolerates ions in the electrolyte. For instance, we added 10 mM Cu(ClO₄)₂ to the electrolyte while applying a potential of 0.50 V. The potential is in the range of Cu underpotential deposition at Pt surfaces. Therefore, if Cu²⁺ could pass through the WO₃ membrane to reach the Pt catalyst, Cu would deposit at the Pt surfaces and thus poison the hydrogen oxidation activity. In our experiments, we did not observe any degradation of hydrogen oxidation current when we added Cu²⁺ to the electrolyte (FIG. 3). The results indicate that the WO₃ membrane prevents the transfer of ionic impurities dissolved in the electrolyte to the catalyst surfaces.

### Increasing the Pt/WO₃ Boundary Improves the Catalytic Activity

Our mechanistic studies of the Pt/WO₃ composite electrode to catalyze the hydrogen oxidation reaction suggest that the rate of the catalysis is controlled by the rate of hydrogen spillover. Furthermore, the rate of hydrogen spillover increases proportionally with increasing PtIWO₃ boundary density. Therefore, we managed to increase the PtIWO₃ boundary density by roughening the WO₃ surfaces and increasing the distribution of Pt catalysts. To roughen the WO₃ surfaces, we used thermal evaporation and post-annealing to deposit the WO₃ membrane. The roughness factor of the thermal evaporated WO₃ membrane is 1.2 times of the sputtered membrane. Accordingly, the current of hydrogen oxidation reaction for the roughened WO₃ membrane almost doubles the current of the smooth WO₃ membrane. The results suggest that the surface area of WO₃ membrane and furthermore, the PtIWO₃ boundary density, significantly affects the rate of catalysis.

We also increased the PtIWO₃ boundary density by increasing the distribution of Pt. We deposited different patterns of Pt catalyst by altering the time duration magnetron sputtering from 20 s to 45 s. From 20 s to 35 s, Pt catalyst distributes as isolated islands with a diameter remaining around 5 nm independent of deposition time. The increase of Pt deposition time increases the density of Pt islands and thus the PtIWO₃ boundary density. For 40 s and 45 s Pt deposition time durations, Pt patterns overlap with each other, thus leading to a decrease of PtIWO₃ boundary density. Accordingly, the hydrogen oxidation current increases with increasing PtIWO₃ boundary density. The results again suggest that the PtIWO₃ boundary density determines the rate of hydrogen spillover and furthermore, the rate of catalysis. Therefore, we are able to control the rate of catalysis by tuning the structure of the Pt/WO₃ composite electrode.

### Incorporation by Reference

All publications and patents mentioned herein are hereby incorporated by reference in their entirety as if each individual publication or patent was specifically and individually indicated to be incorporated by reference. In case of conflict, the present application, including any definitions herein, will control.

### Equivalents

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

1. A device, comprising a porous support substrate, and a film in contact with the porous support substrate, wherein the film comprises:
a first oxide layer; and
an ionic conductor layer; wherein
the oxide is selected from the group consisting of WO₃, WO₂, MoO₃, MoO₂, TiO₂, TiO, ZnO, ZrO₂, ZrO, CeO₂, CeO, TiCeO₂, YCeO₂, carbon, V₂O₅, MoS₂, WS₂, NiOOH, MnO₂, SnO₂, Fe₂O₃, and CrOₓ, wherein x is a number from 0.1 to 3; and
the ionic conductor is selected from the group consisting of an electrolyte, a polymer membrane, and an inorganic compound.

2. A device, comprising a porous support substrate, and a film in contact with the porous support substrate, wherein the film comprises:
a first catalyst layer;
a first oxide layer; and
an ionic conductor layer; wherein
the catalyst is selected from the group consisting of a metal, a metal nitride, a metal oxide, a metal sulfide, a metal carbide, Pt, Pd, Ru, Re, Co, Cu, Rh, CoMo, NiMo, NiW sulfide, Ni, Fe, and Au;
the oxide is selected from the group consisting of WO₃, WO₂, MoO₃, MoO₂, TiO₂, TiO, ZnO, ZrO₂, ZrO, CeO₂, CeO, TiCeO₂, YCeO₂, carbon, V₂O₅, MoS₂, WS₂, NiOOH, MnO₂, SnO₂, Fe₂O₃, and CrOₓ, wherein x is a number from 0.1 to 3; and
the ionic conductor is selected from the group consisting of an electrolyte, a polymer membrane, and an inorganic compound.

3. A device, comprising a porous support substrate, and a film in contact with the porous support substrate, wherein the film comprises:
a first catalyst layer;
a first oxide layer;
an ionic conductor layer;
a second oxide layer; and
a second catalyst layer; wherein
each catalyst is independently selected from the group consisting of a metal, a metal nitride, a metal oxide, a metal sulfide, a metal carbide, Pt, Pd, Ru, Re, Co, Cu, Rh, Pt sulfide, Pd sulfide, Rh sulfide, CoMo sulfide, NiMo sulfide, NiW sulfide, Ni, Fe, and Au;
the oxide is selected from the group consisting of WO₃, WO₂, MoO₃, MoO₂, TiO₂, TiO, ZnO, ZrO₂, ZrO, CeO₂, CeO, TiCeO₂, YCeO₂, carbon, V₂O₅, MoS₂, WS₂, NiOOH, MnO₂, SnO₂, Fe₂O₃, and CrOₓ, wherein x is a number from 0.1 to 3; and
the ionic conductor is selected from the group consisting of an electrolyte, a polymer membrane, and an inorganic compound.

4-6. (canceled)

7. The device of claim 2, wherein the porous support substrate has a thickness of about 10 μm, about 11 μm, about 12 μm, about 13 μm, about 14 μm, about 15 μm, about 16 μm, about 17 μm, about 18 μm, about 19 μm, about 20 μm, about 22 μm, about 24 μm, about 26 μm, about 28 μm, about 30 μm, about 32 μm, about 34 μm, about 36 μm, about 38 μm, about 40 μm, about 42 μm, about 44 μm, about 46 μm, about 48 μm, or about 50 μm.

8. (canceled)

9. The device of claim 2, wherein the pores of the porous support substrate have an average diameter of about 50 nm, about 100 nm, about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 950 nm, or about 1,000 nm.

10-12. (canceled)

13. The device of claim 2, wherein the porous support substrate is a polymer, a ceramic, a metal salt, a metal, or a non-metal.

14. The device of claim 13, wherein the polymer is a polycarbonate, polybenzimidazole, a polystyrene, a polyurethane, cellulose, a polyvinyl chloride, or latex.

15. (canceled)

16. The device of claim 13, wherein the ceramic is AlO₃, TiO₂, ZrO₂, or yttria-stabilized zirconia.

17. The device of claim 13, wherein the metal salt is calcium phosphate.

18. The device of claim 13, wherein the metal is stainless steel, titanium, or silicon.

19. The device of claim 13, wherein the non-metal is carbon.

20. The device of claim 2, wherein the first catalyst layer is Pt or Pd; and the first oxide layer is WO₃.

21. The device of claim 2, wherein the first catalyst layer is Pt or Pd and the first oxide layer is WO₂; the first catalyst layer is Pt or Pd and the first oxide layer is MoO3; the first catalyst layer is Pt or Pd and the first oxide layer is MoO₂; the first catalyst layer is Rh and the first oxide layer is TiO₂; the first catalyst layer is Rh and the first oxide layer is TiO; the first catalyst layer is Cu and the first oxide layer is ZnO; the first catalyst layer is Pt or Rh and the first oxide layer is CeO₂; the first catalyst layer is Pt or Rh and the first oxide layer is CeO; the first catalyst layer is Pd and the first oxide layer is TiCeO₂; the first catalyst layer is Fe, Co, Ni, or Cu and the first oxide layer is TiCeO₂; the first catalyst layer is Fe, Ru or Re and the first oxide layer is TiCeO₂; the first catalyst layer is Ni and the first oxide layer is TiCeO₂; the first catalyst layer is Pd and the first oxide layer is YCeO₂; the first catalyst layer is Fe, Co, Ni, or Cu and the first oxide layer is YCeO₂; the first catalyst layer is Fe, Ru or Re and the first oxide layer is YCeO₂; the first catalyst layer is Pt and the first oxide layer is carbon; the first catalyst layer is Pt or Pd and the first oxide layer is V₂O₅; the first catalyst layer is Pt sulfide, Pd sulfide, Rh sulfide, CoMo sulfide, NiMo sulfide, or NiW sulfide and the first oxide layer is MoS₂; the first catalyst layer is Pt sulfide, Pd sulfide, Rh sulfide, CoMo sulfide, NiMo sulfide, or NiW sulfide and the first oxide layer is WS₂; the first catalyst layer is Pd and the first oxide layer is NiOOH; the first catalyst layer is Pd or Pt and the first oxide layer is MnO₂; the first catalyst layer is Pd or Pt and the first oxide layer is SnO₂; the first catalyst layer is Sn and the first oxide layer is SnO₂; the first catalyst layer is Fe, Co, Ni, or Cu and the first oxide layer is SnO₂; the first catalyst layer is Fe, Ru, or Re and the first oxide layer is SnO₂; the first catalyst layer is Pt and the first oxide layer is Fe₂O₃; the first catalyst layer is Au and the first oxide layer is Fe₂O₃; the first catalyst layer is Pt and the first oxide layer is CrO₂; the first catalyst layer is Pt or Rh and the first oxide layer is ZrO₂; or the first catalyst layer is Pt or Rh and the first oxide layer is ZrO; wherein x is a number from 0.1 to 3.

22-82. (canceled)

83. The device of claim 2, wherein the first catalyst layer has a thickness of about 1 nm, about 2 nm, about 3 nm, about 4 nm, about 5 nm, about 6 nm, about 7 nm, about 8 nm, about 9 nm, or about 10 nm, about 25 nm, about 50 nm, about 75 nm, about 100 nm, about 125 nm, about 150 nm, about 175 nm, about 200 nm, about 225 nm, about 250 nm, about 275 nm, about 300 nm, about 325 nm, about 350 nm, about 375 nm, about 400 nm, about 425 nm, about 450 nm, about 475 nm, or about 500 nm.

84-88. (canceled)

89. The device of claim 2, wherein the first oxide layer has a thickness of about 0.5 μm, about 1μm, about 1.5 μm, about 2.0 μm, about 2.5 μm, about 5μm, about 7.5 μm, about 10 μm, about 12.5 μm, or about 15 μm.

90-93. (canceled)

94. The device of claim 2, wherein the electrolyte is an aqueous acidic solution, an aqueous neutral solution, or an aqueous basic solution.

95. The device of claim 94, wherein the aqueous electrolyte comprises NaClO₄ or HClO₄.

96. (canceled)

97. (canceled)

98. The device of claim 2, wherein the electrolyte is a non-aqueous electrolyte and the non-aqueous electrolyte is selected from an alcohol, an ether, an acetate, a carboxylic acid, a nitrile, a formamide, an acetamide, a sulfoxide, a halogenated hydrocarbon, a ketone, or a non-aqueous acid.

99. (canceled)

100. (canceled)

101. The device of claim 98, wherein the non-aqueous electrolyte is N-methylpyrrolidone, dimethylcarbonate, ethyl methyl carbonate, propylene carbonate, phosphoric acid, ethylene carbonate, acetonitrile, methanol, ethanol, propanol, butanol, isopropanol, acetic acid, trifluoroactic acid, butanoic acid, propanoic acid, dimethyl formamide, dimethylacetatemide, dimethyl sulfoxide, tetrahydrofuran, methyltetrahydrofuran, dichloromethane, trichloroethane, tetrachloromethane, dichloroethane, ethyl acetate, methyl acetate, propyl acetate, or acetone.

102. The device of claim 2, wherein the inorganic compound is cesium hydrogen sulfate, cesium dihydrogen phosphate, aluminum oxide, or a cerate perovskite.

103. The device of claim 2, the polymer membrane is a sulfonated tetrafluoroethylene fluoropolymer-copolymer.

104. The device of claim 103, wherein the polymer is tetrafluoroethylene-perfluoro-3,6-dioxa-4-methyl-7-octenesulfonic acid copolymer.

105-107. (canceled)

108. A method of hydrogen oxidation, comprising the steps of
contacting a device of claim 2 with a source of hydrogen, thereby forming a reaction mixture; and
applying an electrical potential to the reaction mixture.

109-145. (canceled)

146. The device of claim 2, wherein the first oxide layer is electrocatalytically inert.
